(19) United States
(12) Patent Application Publication
(10) Pub. No.: US 2025/0173399 A1
(43) Pub. Date: May 29, 2025

(54) ARITHMETIC PROCESSING APPARATUS

(71) Applicant: NATIONAL INSTITUTE OF ADVANCED INDUSTRIAL SCIENCE AND TECHNOLOGY, Tokyo (JP)

(72) Inventor: Shinichi Ouchi, Ibaraki (JP)

(73) Assignee: NATIONAL INSTITUTE OF ADVANCED INDUSTRIAL SCIENCE AND TECHNOLOGY, Tokyo (JP)

(21) Appl. No.: 19/036,053

(22) Filed: Jan. 24, 2025

Related U.S. Application Data
(63) Continuation of application No. PCT/JP2023/027078, filed on Jul. 24, 2023.

(30) Foreign Application Priority Data
Jul. 25, 2022 (JP) 2022-117909

(51) Int. Cl. G06F 17/16

(52) U.S. Cl. CPC G06F 17/16

(57) ABSTRACT

An arithmetic processing apparatus is a system for matrix multiplication using M arithmetic units connected in series. It processes two M×N-dimensional input matrices (a and b) to produce an M×M-dimensional output matrix (x). Each arithmetic unit stores and processes a specific column vector pair from the input matrices. The calculation occurs through a distributed process where each Mth arithmetic unit stores corresponding column vectors [am, bm] from matrices a and b, column vectors bm are sequentially propagated through the network, each unit calculates dot products between its stored am vector and all incoming b vectors, and the resulting dot products form M-dimensional column vectors (xm) that make up the final output matrix. This distributed approach allows parallel processing of matrix multiplication across the network of arithmetic units, with each unit contributing a portion of the final result.

### CROSS-REFERENCE TO RELATED APPLICATIONS

This application is a continuation application of PCT International Application No. PCT/JP2023/027078, filed on Jul. 24, 2023, which is based on and claims priority to Japanese patent application JP 2022-117909, filed Jul. 25, 2022, each are incorporated herein by reference in their entirety.

### TECHNICAL FIELD

The present disclosure relates to an arithmetic system, and more particularly to an arithmetic processing apparatus which efficiently performs machine learning processing.

### BACKGROUND

The speed of machine learning has dramatically improved through general-purpose computing on a graphical processing unit (GPGPU: General Purpose computing on GPU).

Meanwhile, not only network models of machine learning using simple convolution operations but also those using vector inner product operations called attention mechanisms have become known for many useful applications such as automatic translation and image processing (see, for example, Patent Literature (hereinafter, referred to as “PTL”) 1 and Non-Patent Literatures (hereinafter, referred to as “NPLs”) 1 and 2).

### CITATION LIST

### Patent Literature

PTL 1
Japanese Patent Application Laid-Open No. 2022-019422

### Non-Patent Literature

NPL 1
A. Vaswani et al., “Attention is all you need”, 31st Conference on Neural Information Processing Systems (NIPS 2017), Long Beach, CA, USA, Dec. 4-9, 2017. https://proceedings.neurips.cc/paper/2017/file/3f5ee243547dee91fbd053c1c4a845aa-Paper.pdf
NPL2
A. Dosovitskiy et al., “An image is worth 16×16 words: transformers for image recognition at scale”, The 9th International Conference on Learning Representations (ICLR 2021), Virtual Only, May 3-7, 2021. https://iclr.cc/virtual/2021/poster/3013

### SUMMARY

According to an aspect an arithmetic processing apparatus is described or provided. The arithmetic processing apparatus can comprise a plurality of arithmetic units connected to one another in a series in a network, wherein the plurality of arithmetic units are configured to, with respect to an M×N-dimensional first matrix a=[a₀, a₁, a₂, . . . , a_{M-1}] and an M×N-dimensional second matrix b=[b₀, b₁, b₂, . . . , b_{M-1}] each including M N-dimensional column vectors, for performing a calculation of obtaining an M×M-dimensional third matrix x=[x₀, x₁, x₂, . . . , x_{M-1}] by a product of matrices x=a^{T}b, the M×M-dimensional third matrix including M M-dimensional column vectors having, as elements, dot products for combinations of all column vectors belonging to the M×N-dimensional first matrix and the M×N-dimensional second matrix, store one set of column vectors [aₘ, bₘ] of the M×N-dimensional first matrix a=[a₀, a₁, a₂, . . . , a_{M-1}] and the M×N-dimensional second matrix b=[b₀, b₁, b₂, . . . , b_{M-1}] in a corresponding mth one of M arithmetic units being minimum component units of the arithmetic processing apparatus, send array data of N-dimensional column vectors bₘ from any arithmetic unit of the M arithmetic units, and propagate the array data sequentially to an adjacent arithmetic unit at a subsequent stage, calculate, in the mth arithmetic unit of the M arithmetic units, dot products of column vectors b₀, b₁, b₂, . . . , b_{M-1} of the M×N-dimensional second matrix and aₘ that is stored in an arithmetic unit of the M arithmetic units, the dot products being M-dimensional column vectors xₘ=[aₘ·b₀, aₘ·b₁, aₘ·b₂, . . . , aₘ·b_{M-1}]^{T} forming a part of an array of the M×M-dimensional third matrix, and store the M-dimensional column vectors xₘ in the mth arithmetic unit of the M arithmetic units, wherein aₘ, bₘ, and xₘ are column vectors stored in the M arithmetic units as arrays.

### BRIEF DESCRIPTION OF DRAWINGS

FIG. 1 illustrates a schematic configuration of an arithmetic processing apparatus according to one or more aspects of the present disclosure;

FIG. 2 is an explanatory diagram of an operation of obtaining dot products xₘ=[aₘ·b₀, aₘ·b₁, aₘ·b₂, . . . , aₘ·b_{M-1}]^{T} in one or more aspects of the present disclosure;

FIG. 3 is an explanatory diagram of an operation of obtaining M N-dimensional column vectors by a product of an M×M-dimensional matrix including M M-dimensional column vectors xₘ and a matrix c=[c₀, c₁, c₂, . . . , c(_{M-1})] including M N-dimensional column vectors in one or more aspects of the present disclosure; and

FIG. 4 is an explanatory diagram of an operation of processing a linear layer in one or more aspects of the present disclosure.

### DETAILED DESCRIPTION

### Technical Problems

An image processing operation apparatus is generally made to have high versatility so that it can execute many types of matrix operations, and has a structure in which specific processing is performed by a software library that runs on the apparatus. In this case, it is known that extra consumption power is consumed for general-purpose use and that the speed decreases due to software processing. In contrast, creating a fully dedicated circuit results in a disadvantage of being unable to perform other calculations.

The present disclosure describes an arithmetic processing apparatus capable of speeding up the calculation of a network model based on an attention mechanism (hereinafter, also referred to as “attention”).

### Solutions to Problems

According to one or more aspects of the present disclosure, an arithmetic processing apparatus may comprise a plurality of arithmetic units connected to one another in a series in a network, wherein the plurality of arithmetic units are configured to, with respect to an M×N-dimensional first matrix a=[a₀, a₁, a₂, . . . , a_{M-1}] and an M×N-dimensional second matrix b=[b₀, b₁, b₂, . . . , b_{M-1}] each including M N-dimensional column vectors, for performing a calculation of obtaining an M×M-dimensional third matrix x=[x₀, x₁, x₂, . . . , x_{M-1}] by a product of matrices x=a^{T}b, the M×M-dimensional third matrix including M M-dimensional column vectors having, as elements, dot products for combinations of all column vectors belonging to the M×N-dimensional first matrix and the M×N-dimensional second matrix, store one set of column vectors [aₘ, bₘ] of the M×N-dimensional first matrix a=[a₀, a₁, a₂, . . . , a_{M-1}] and the M×N-dimensional second matrix b=[b₀, b₁, b₂, . . . , b_{M-1}] in a corresponding mth one of M arithmetic units being minimum component units of the arithmetic processing apparatus, send array data of N-dimensional column vectors bₘ from any arithmetic unit of the M arithmetic units, and propagate the array data sequentially to an adjacent arithmetic unit at a subsequent stage, calculate, in the mth arithmetic unit of the M arithmetic units, dot products of column vectors b₀, b₁, b₂, . . . , b_{M-1} of the M×N-dimensional second matrix and aₘ that is stored in the mth one of the M arithmetic units, the dot products being M-dimensional column vectors xₘ=[aₘ·b₀, aₘ·b₁, aₘ·b₂, . . . , aₘ·b_{M-1}]^{T} forming a part of an array of the M×M-dimensional third matrix, and store the M-dimensional column vectors xₘ in the mth arithmetic unit of the M arithmetic units, wherein aₘ, bₘ, and xₘ are column vectors stored in the M arithmetic units as arrays.

For example, the arithmetic processing apparatus may be configured to, when calculating a column vector yₘ represented by the following equation 1,

$$[ 1 ]$$

$${y}_{m} = {[ {\sum }_{i = 0}^{M - 1} {c}_{i 0} {x}_{mi} , {\sum }_{i = 0}^{M - 1} {c}_{i 1} {x}_{mi} , \\ {\sum }_{i = 0}^{M - 1} {c}_{i 2} {x}_{mi} , … {\sum }_{i = 0}^{M - 1} {c}_{i ( N - 1 )} {x}_{mi} ]}^{T} , \qquad ( Equation 1 )$$

which is stored in the mth arithmetic unit and forms a part of data of a fifth matrix generated by matrix products y=[y₀, y₁, y₂, . . . , y_{M-1}]=cx from the M-dimensional column vectors xₘ stored in the mth arithmetic unit and belonging to the M×M-dimensional third matrix, and from an M×N-dimensional fourth matrix c=[c₀, c₁, c₂, . . . , c_{M-1}] stored in advance, send an element of an N-dimensional column vector cₘ stored in each arithmetic unit to the network in an order of cₘ₀, cₘ₁, cₘ₂, . . . , c_{m(N-1)} using the network in which the arithmetic units are connected to one another in series, calculate the N-dimensional column vector yₘ, and store the N-dimensional column vector yₘ in a corresponding mth arithmetic unit.

In the above aspects, the arithmetic processing apparatus may be configured to, for performing a calculation of a linear layer for M channels with respect to a column vector dₘ=[dₘ₀, dₘ₁, dₘ₂, . . . , d_{m(L-1)}]^{T} that constitutes an M×L-dimensional matrix, input, sequentially, an N×L-dimensional coefficient matrix U or an N-dimensional bias vector V from an outside into to be propagated through the network being in series connection, calculate zₘ represented by the following equation 2, together with the column vector dₘ stored in advance in a corresponding mth arithmetic unit,

$$[ 2 ]$$

$${z}_{m} = {[ {\sum }_{i = 0}^{i - 1} {u}_{0 i} {d}_{mi} + {v}_{0} , {\sum }_{i = 0}^{L - 1} {u}_{1 i} {d}_{mi} + {v}_{1} , \\ {\sum }_{i = 0}^{L - 1} {u}_{2 i} {d}_{mi} + {v}_{2} , … , {\sum }_{i = 0}^{L - 1} {u}_{( N - 1 ) l} {x}_{mi} + {v}_{( N - 1 )} ]}^{T} , \qquad ( Equation 2 )$$

store an mth N-dimensional column vector zₘ in a corresponding one of the arithmetic units, wherein u and v represent an element of the N×L-dimensional coefficient matrix U and an element of the N-dimensional bias vector V, respectively.

In the above aspects, the arithmetic processing apparatus may be configured to, for implementing a multi-head attention, the arithmetic processing apparatus includes a set of the network and the M arithmetic units for each of H heads, divide a number of rows of a coefficient matrix of a linear layer immediately before division among the heads by the number H of heads, input, sequentially, a segment matrix resulting from the division is sequentially input into a communication channel for an hth head, respectively, and calculate zₕₘ represented by the following equation 3, together with the shared computed vector data dₘ,

$$[ 3 ]$$

$${z}_{hm} = {[ {\sum }_{i = 0}^{L - 1} {u}_{hi 0} {d}_{m 1} + {v}_{hm 0} , {\sum }_{i = 0}^{L - 1} {u}_{hi 1} {d}_{mi} + {v}_{hm 1} , \\ {\sum }_{i = 0}^{L - 1} {u}_{hi 2} {d}_{mi} + {v}_{hm 2} , … , {\sum }_{i = 0}^{L - 1} {u}_{hi ( N / H - 1 )} {x}_{mi} + {v}_{hm ( N / H - 1 )} ]}^{T} . \qquad ( Equation 3 )$$

The arithmetic processing apparatus may be configured to, for implementing the multi-head attention, in order to concatenate vectors for multiple heads, divide, by the number H of heads, a number of columns of the coefficient matrix of the linear layer immediately after combination of vectors of the multiple heads, input a segment matrix resulting from the division sequentially into the communication channel for the hth head, sum partial sums for each head of the heads, and store the sum of the partial sums in a predetermined arithmetic unit.

In the above aspects, the arithmetic processing apparatus may be configured to include the network including, as a basic structure, a data readout daisy chain configured to sequentially read out data to the network and a data input daisy chain configured to input data to the arithmetic units, wherein an output of the data readout daisy chain is connected with an input of the data input daisy chain, and wherein the data input daisy chain is further configured to input, sequentially, the read data to the arithmetic units in series.

In the above aspects, the arithmetic processing apparatus may be configured to propagate an arithmetic code together with data sequentially in series to the network.

In the above aspects, the arithmetic processing apparatus may be configured to, in order to perform processing of column vector data of multiple heads without adding hardware, simulate multi-head processing by performing transfer and receiving of arrays and accumulation of product-sum operations dividedly and sequentially in a head order.

The arithmetic processing apparatus may include, in order to address an issue with a different number of channels or a different number of sequences, the network that is divided according to a number of channels or a number of sequences, and a circuit element configured to couple the data readout daisy chain to the data input daisy chain.

### Advantageous Effects

According to the above aspects, the network is capable of performing almost all processing by sending data only to adjacent arithmetic elements, except for the processing of adding partial sums when matrices are combined. Accordingly, a high parallelism that is mutually independent is achieved, and it is thus possible to accelerate the calculation of the network model based on an attention mechanism.

Next, the present disclosure will be described with reference to the drawings.

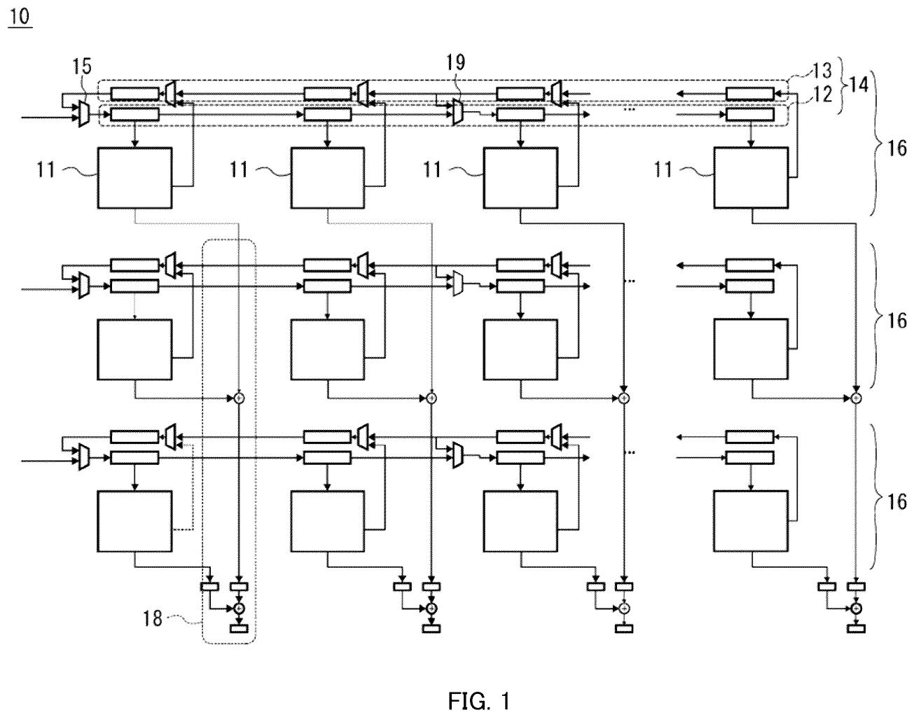

FIG. 1 illustrates a schematic configuration of an arithmetic processing apparatus according to an embodiment of the present disclosure. Referring to FIG. 1, an arithmetic processing apparatus 10 includes a plurality of arithmetic units 11. The plurality of arithmetic units 11 are connected to a network 14, which exchanges data through a first daisy chain 12 that propagates data in the right direction and a second daisy chain 13 that propagates data in the left direction. The first and second daisy chains 12 and 13 are coupled to each other by a first multiplexer 15, and it is also possible to input data directly into the first daisy chain 12 from the outside. A set of these components is referred to as an arithmetic unit set 16.

The arithmetic processing apparatus 10 includes H arithmetic unit sets 16 independently in order to perform segment matrix processing, that is, multi-head processing with H-way parallelism. An addition network 18 for summing H-divided partial sums when the inner products of the divided rows and columns are performed instead of combining the matrices after the segment matrix processing is completed is disposed orthogonally to the first and second daisy chains 12 and 13. Note that, in a case where the cost for implementing an arithmetic unit set is high, the processing may be performed by a separate Central Processing Unit (CPU) or the like. Further, the arithmetic processing apparatus 10 includes a second multiplexer 19 for appropriately propagating data in a case where the first and second daisy chains 12 and 13 are divided in accordance with the number of dimensions of the vectors to be processed. Hereinafter, a method for calculating a dot product or a linear layer in the present embodiment is described.

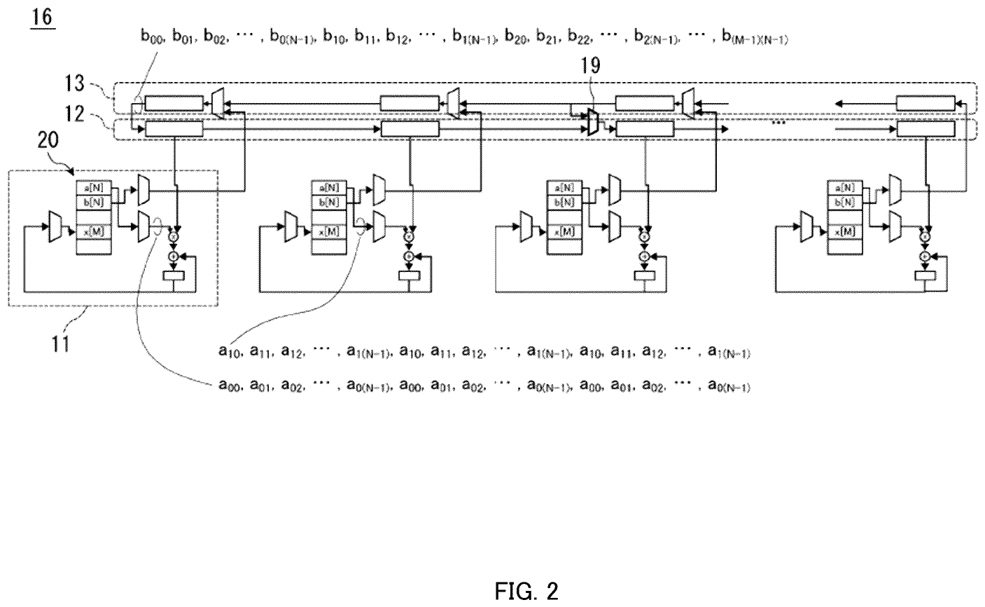

FIG. 2 is an explanatory diagram of an operation of obtaining a set of dot products xₘ=[aₘ·b₀, aₘ·b₁, aₘ·b₂, . . . , aₘ·b_{M-1}]^{T} in an embodiment of the present disclosure, and shows the most basic calculation method for performing dot products. In FIG. 2, a case where the initial sequence length is switched between 2 and M by the second multiplexer 19 is illustrated for the arithmetic unit sets 16. Referring to FIG. 2 in conjunction with FIG. 1, in a case where the sequence length is M, obtaining M M-dimensional column vectors xₘ=[aₘ·b₀, aₘ·b₁, aₘ·b₂, . . . , aₘ·b_{M-1}]^{T}, where m=0, 1, 2, . . . , M-1, calculated by matrix products a^{T}b of first matrix a=[a₀, a₁, a₂, . . . , a_{M-1}] and second matrix b=[b₀, b₁, b₂, . . . , b_{M-1}], which are M×N-dimensional matrices, is considered. Each of the arithmetic unit sets 16 of the arithmetic processing apparatus 10 includes M arithmetic units 11, which are the minimum component unit. IDs of the arithmetic units 11 are m=0, 1, 2, . . . , M-1. One arithmetic unit 11 includes a scratch pad SRAM 20 inside, and stores N-dimensional arrays aₘ and bₘ corresponding to the ID number m inside the arithmetic unit 11. The arrays aₘ and bₘ are column vectors.

When calculating the products x=a^{T}b of the matrix derived from the first matrix a and the second matrix b, that is, M M-dimensional column vectors xₘ=[aₘ·b₀, aₘ·b₁, aₘ·b₂, . . . , aₘ·b_{M-1}]^{T}, the arithmetic unit set 16 continuously outputs the elements of bₘ from the arithmetic unit 11 to the second daisy chain 13 in the following sequences: b₀=[b₀₀, b₀₁, b₀₂, . . . , b_{0(N-1)}], b₁=[b₁₀, b₁₁, b₁₂, . . . , b_{1(N-1)}], b₂=[b₂₀, b₂₁, b₂₂, . . . , b_{2(N-1)}], . . . , b_{M-1}=[b_{(M-1)0}, b_{(M-1)1}, b_{(M-1)2}, . . . , b_{(M-1)(N-1)}]. These arrays are transferred to the first daisy chain 12 by the first multiplexer 15, and the arithmetic unit 11 receives data bₘₙ in order from m=0 and executes the product-sum operation. By transferring array data b in this order, the products can be continuously accumulated. The resulting data of N-dimensional column vectors xₘ is stored in the scratch pad SRAM 20 again. On the other hand, in a case where the initial sequence length is M=2, a path is selected such that the subsequent elements at m=2 and thereafter are shortcut to the second daisy chain 13 by the second multiplexer 19, and another sequence different from the sequences of sequence length 2 using m=0, 1 can be handled. It is understood by those skilled in the art that the present calculation corresponds to the dot product attention of query q and key k in, for example, a Transformer.

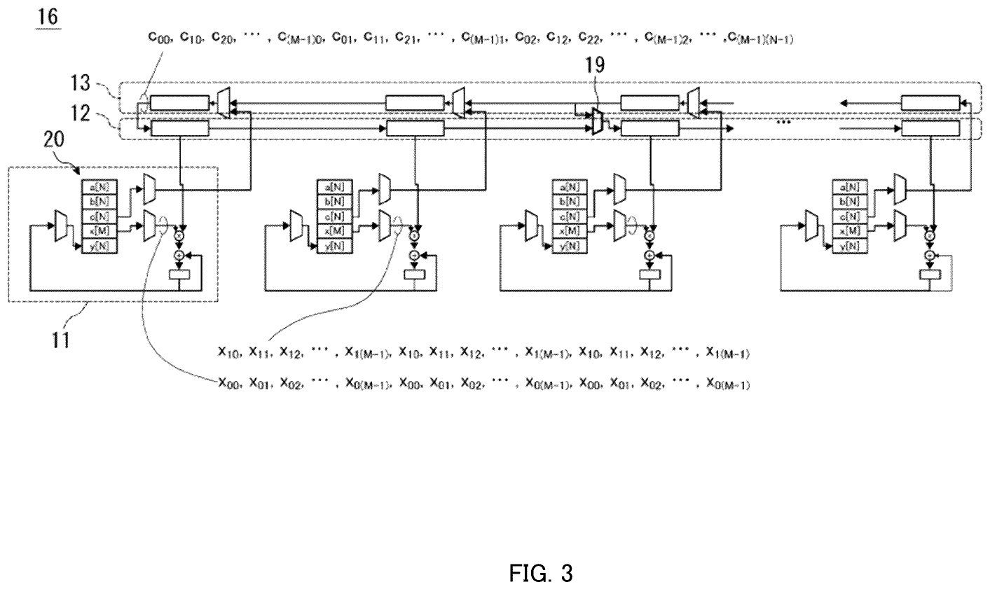

FIG. 3 illustrates an operation of obtaining M N-dimensional column vectors by multiplying an M×M-dimensional matrix including M M-dimensional column vectors xₘ by a matrix c=[c₀, c₁, c₂, . . . , c(_{M-1})] including M N-dimensional column vectors in an embodiment of the present disclosure. In FIG. 3, the arithmetic unit set 16 is illustrated in a case where the initial sequence length is 2. Referring to FIG. 3, a calculation method for generating M N-dimensional column vectors by the products of a matrix x=[x₀, x₁, x₂, . . . , x_{M-1}] representing M M-dimensional column vectors generated by the method illustrated in FIG. 2 and the matrix c=[c₀, c₁, c₂, . . . , c(_{M-1})] of M N-dimensional arrays is illustrated. That is, when calculating a column vector yₘ represented by the following equation 4,

$$[ 4 ]$$

$${y}_{m} = {[ {\sum }_{i = 0}^{M - 1} {c}_{i 0} {x}_{mi} , {\sum }_{i = 0}^{M - 1} {c}_{i 1} {x}_{mi} , \\ {\sum }_{i = 0}^{M - 1} {c}_{i 2} {x}_{mi} , … {\sum }_{i = 0}^{M - 1} {c}_{i ( N - 1 )} {x}_{mi} ]}^{T} \qquad ( Equation 4 )$$

the arithmetic unit set 16 reads, from each arithmetic unit 11, the set c of arrays stored in each of the arithmetic units 11 in an order of c₀₀, c₁₀, c₂₀, . . . , c_{(M-1)0}, c₀₁, c₁₁, c₂₁, . . . , c_{(M-1)1}, c₀₂, c₁₂, . . . , c_{(M-1)(N-1)} different from the order in FIG. 2 by the second daisy chain 13, and receives data bₘ in order from m=0 of the arithmetic unit 11 to execute the product-sum operation. The resulting N-dimensional data yₘ is stored again in the scratch pad SRAM 20. It is understood by those skilled in the art that the present calculation corresponds to the weighted output calculation y=av of v by dot product attention a in, for example, the Transformer. Here, for the sake of simplicity, the description does not assume segment matrix processing, that is, multi-head processing.

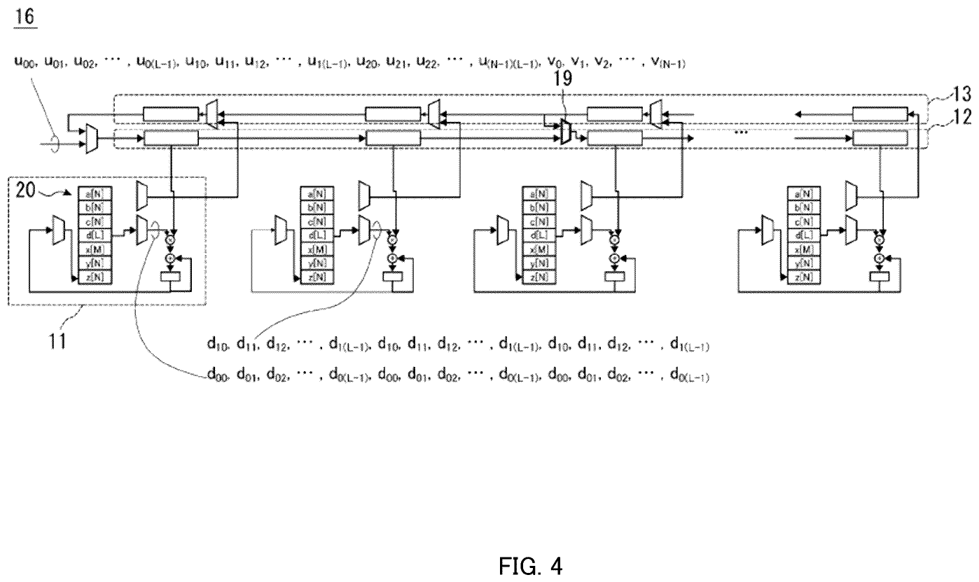

FIG. 4 is an explanatory diagram of an operation of processing a linear layer in an embodiment of the present disclosure, and illustrates a method of performing a calculation of the linear layer in the structure illustrated in FIG. 1. Referring to FIG. 4, when calculating M N-dimensional arrays zₘ represented by the following equation 5 from M channels or M sequences of L-dimensional vector data, that is, M L-dimensional arrays dₘₗ, the arithmetic unit set 16 inputs matrix elements uₙₗ, vₙ from the first daisy chain 12, which propagates data to the right from the outside via the first multiplexer 15, in the order of u₀₀, u₀₁, u₀₂, . . . , u_{0(L-1)}, u₁₀, u₁₁, u₁₂, . . . , u_{1(L-1)}, u₂₀, u₂₁, . . . , u_{(N-1)(L-1)}, v₀, v₁, v₂, . . . , v_{(N-1)}, and receives data uₙₗ, vₙ in order from m=0 of the arithmetic unit 11 to execute the product-sum operation:

$$[ 5 ]$$

$${z}_{m} = {[ {\sum }_{i = 0}^{L - 1} {u}_{0 i} {d}_{mi} + {v}_{0} , {\sum }_{i = 0}^{L - 1} {u}_{1 i} {d}_{mi} + {v}_{1} , \\ {\sum }_{i = 0}^{L - 1} {u}_{2 i} {d}_{mi} + {v}_{2} , … , {\sum }_{i = 0}^{L - 1} {u}_{( N - 1 ) i} {x}_{mi} + {v}_{( N - 1 )} ]}^{T} . \qquad ( Equation 5 )$$

The resulting N-dimensional data zₘ is stored again in the scratch pad SRAM 20. The present calculation corresponds to generating each vector of query q, key k, and value v from arbitrary vector data by a linear layer, for example, in the Transformer. Here, for the sake of simplicity, the segment matrix processing is not assumed.

FIGS. 2 to 4 describe the case where the segment matrix processing is not performed. In a case where the segment matrix processing is introduced, it is possible to implement multi-head attention by the arithmetic processing apparatus 10 including the arithmetic unit sets 16 for the number H of heads as illustrated in FIG. 1, in which the number of rows of the coefficient matrix of the linear layer immediately before division among the heads is divided, the rows of the coefficient matrix are sequentially inputted into head communication channels, and the array zₕₘ represented by the following equation 6 is calculated with the coefficient matrix and shared vector data to be operated:

$$[ 6 ]$$

$${z}_{hm} = {[ {\sum }_{i = 0}^{L - 1} {u}_{hi 0} {d}_{mi} + {v}_{hm 0} , {\sum }_{i = 0}^{L - 1} {u}_{hi 1} {d}_{mi} + {v}_{hm 1} , \\ {\sum }_{i = 0}^{L - 1} {u}_{hi 2} {d}_{mi} + {v}_{hm 2} , … , {\sum }_{i = 0}^{L - 1} {u}_{hi ( N / H - 1 )} {x}_{mi} + {v}_{hm ( N / H - 1 )} ]}^{T} . \qquad ( Equation 6 )$$

Here, the operation of the operated vector in the linear layer can be performed by providing a common copy of the operated vector in the arithmetic unit related to the segment matrix processing, and can also be realized by providing a communication channel shared in the head division direction or by providing a storage area common to the units related to the segment matrix processing.

Further, combining matrices divided among multiple heads can be achieved by functions of dividing the coefficient matrix of the linear layer in the column direction that performs the operation immediately after the combination, sequentially inputting it into each head communication channel, summing partial sums divided among the heads by the addition network 18 shown in FIG. 1, and storing the sum in a predetermined arithmetic unit.

Since arithmetic codes are executable by propagating the operation codes sequentially to the arithmetic units 11 in order to execute an instruction, the operation codes may be transmitted along the first daisy chain 12 or/and the second daisy chain 13 of the network 14.

In FIG. 1, the number of arithmetic units 11 is increased according to the number H of heads. However, in a case where the number of arithmetic resources is limited, it is also possible to simulate multi-head processing by increasing only the storage capacity of the scratch pad SRAM 20 and performing the transfer and the receiving of the arrays and the accumulation of the results of the product-sum operation dividedly and sequentially in a head order.

Further, as illustrated in FIG. 2 and the description of the figure, it is possible to form a plurality of arithmetic processing paths corresponding to short sequences by dividing the network 14 into channels or sequences accordingly by the second multiplexer 19 and by coupling the first daisy chain 12 for data reading and the second daisy chain 13 for input with each other at short sections in order to handle to problems with different numbers of channels or sequences.

### REFERENCE SIGNS LIST

10 Arithmetic processing apparatus
11 Arithmetic unit
12 First daisy chain
13 Second daisy chain
14 Network
15 First multiplexer
16 Arithmetic unit set
18 Addition network
19 Second multiplexer
20 Scratch pad SRAM

1. An arithmetic processing apparatus, comprising:
a plurality of arithmetic units connected to one another in a series in a network,
wherein the plurality of arithmetic units are configured to
with respect to an M×N-dimensional first matrix a=[a₀, a₁, a₂, . . . , a_{M-1}] and an M×N-dimensional second matrix b=[b₀, b₁, b₂, . . . , b_{M-1}] each including M N-dimensional column vectors,
for performing a calculation of obtaining an M×M-dimensional third matrix x=[x₀, x₁, x₂, . . . , x_{M-1}] by a product of matrices x=a^{T}b, the M×M-dimensional third matrix including M M-dimensional column vectors having, as elements, dot products for combinations of all column vectors belonging to the M×N-dimensional first matrix and the M×N-dimensional second matrix,
store one set of column vectors [aₘ, bₘ] of the M×N-dimensional first matrix a=[a₀, a₁, a₂, . . . , a_{M-1}] and the M×N-dimensional second matrix b=[b₀, b₁, b₂, . . . , b_{M-1}] in a corresponding mth one of M arithmetic units being minimum component units of the arithmetic processing apparatus,
send array data of N-dimensional column vectors bₘ from any arithmetic unit of the M arithmetic units, and propagate the array data sequentially to an adjacent arithmetic unit at a subsequent stage,
calculate, in the mth arithmetic unit of the M arithmetic units, dot products of column vectors b₀, b₁, b₂, . . . , b_{M-1} of the M×N-dimensional second matrix and aₘ that is stored in the mth one of the M arithmetic units, the dot products being M-dimensional column vectors xₘ=[aₘ·b₀, aₘ·b₁, aₘ·b₂, . . . , aₘ·b_{M-1}]^{T} forming a part of an array of the M×M-dimensional third matrix, and
store the M-dimensional column vectors xₘ in the mth arithmetic unit of the M arithmetic units,
wherein aₘ, bₘ, and xₘ are column vectors stored in the M arithmetic units as arrays.

2. The arithmetic processing apparatus according to claim 1, wherein:
when calculating a column vector yₘ represented by the following equation 7,
$$[ 7 ]$$
$${y}_{m} = {[ {\sum }_{i = 0}^{M - 1} {c}_{i 0} {x}_{mi} , {\sum }_{i = 0}^{M - 1} {c}_{i 1} {x}_{mi} , \\ {\sum }_{i = 0}^{M - 1} {c}_{i 2} {x}_{mi} , … {\sum }_{i = 0}^{M - 1} {c}_{i ( N - 1 )} {x}_{mi} ]}^{T} , \qquad ( Equation 7 )$$
which is stored in the mth arithmetic unit and forms a part of data of a fifth matrix generated by matrix products y=[y₀, y₁, y₂, . . . , y_{M-1}]=cx from the M-dimensional column vectors xₘ stored in the mth arithmetic unit and belonging to the M×M-dimensional third matrix, and from an M×N-dimensional fourth matrix c=[c₀, c₁, c₂, . . . , c_{M-1}] stored in advance,
the arithmetic processing apparatus is further configured to
send an element of an N-dimensional column vector cₘ stored in each arithmetic unit to the network in an order of cₘ₀, cₘ₁, cₘ₂, . . . , c_{m(N-1)} using the network in which the arithmetic units are connected to one another in series,
calculate the N-dimensional column vector yₘ, and
store the N-dimensional column vector yₘ in a corresponding mth arithmetic unit.

3. The arithmetic processing apparatus according to claim 1, wherein:
for performing a calculation of a linear layer for M channels with respect to a column vector dₘ=[dₘ₀, dₘ₁, dₘ₂, . . . , d_{m(L-1)}]^{T} that constitutes an M×L-dimensional matrix,
the arithmetic processing apparatus is further configured to
input, sequentially, an N×L-dimensional coefficient matrix U or an N-dimensional bias vector V from an outside to be propagated through the network being in series connection,
calculate zₘ represented by the following equation 8, together with the column vector dₘ stored in advance in a corresponding mth arithmetic unit, and
$$[ 8 ]$$
$${z}_{m} = {[ {\sum }_{i = 0}^{L - 1} {u}_{0 i} {d}_{mi} + {v}_{0} , {\sum }_{i = 0}^{L - 1} {u}_{1 i} {d}_{mi} + {v}_{1} , \\ {\sum }_{i = 0}^{L - 1} {u}_{2 i} {d}_{mi} + {v}_{2} , … , {\sum }_{i = 0}^{L - 1} {u}_{( N - 1 ) i} {x}_{mi} + {v}_{( N - 1 )} ]}^{T} , \qquad ( Equation 8 )$$
store an mth N-dimensional column vector zₘ in a corresponding one of the arithmetic units,
wherein u and v represent an element of the N×L-dimensional coefficient matrix U and an element of the N-dimensional bias vector V, respectively.

4. The arithmetic processing apparatus according to claim 1, wherein:
for implementing a multi-head attention,
the arithmetic processing apparatus includes a set of the network and the M arithmetic units for each of H heads,
the arithmetic processing apparatus is further configured to
divide a number of rows of a coefficient matrix of a linear layer immediately before division among the heads by the number H of heads,
input, sequentially, a segment matrix resulting from the division into a communication channel for an hth head, respectively, and
calculate zₕₘ represented by the following equation 9, together with the shared computed vector data dₘ,
$$[ 9 ]$$
$${z}_{hm} = {[ {\sum }_{i = 0}^{L - 1} {u}_{hi 0} {d}_{mi} + {v}_{hm 0} , {\sum }_{i = 0}^{L - 1} {u}_{hi 1} {d}_{mi} + {v}_{hm 1} , \\ {\sum }_{i = 0}^{L - 1} {u}_{hi 2} {d}_{mi} + {v}_{hm 2} , … , {\sum }_{i = 0}^{L - 1} {u}_{hi ( N / H - 1 )} {x}_{mi} + {v}_{hm ( N / H - 1 )} ]}^{T} . \qquad ( Equation 9 )$$

5. The arithmetic processing apparatus according to claim 4, wherein
for implementing a multi-head attention,
in order to concatenate vectors for multiple heads, the arithmetic processing apparatus is further configured to
divide, by the number H of heads, a number of columns of the coefficient matrix of the linear layer immediately after combination of vectors of the multiple heads,
input a segment matrix resulting from the division sequentially into the communication channel for the hth head,
sum partial sums for each head of the heads, and
store the sum of the partial sums in a predetermined arithmetic unit.

6. The arithmetic processing apparatus according to claim 1, comprising:
the network including, as a basic structure, a data readout daisy chain configured to sequentially read out data to the network and a data input daisy chain configured to input data to the arithmetic units,
wherein an output of the data readout daisy chain is connected with an input of the data input daisy chain, and
wherein the data input daisy chain is further configured to input, sequentially, the read data to the arithmetic units in series.

7. The arithmetic processing apparatus according to claim 6, wherein
the arithmetic processing apparatus is further configured to propagate an arithmetic code together with data sequentially in series to the network.

8. The arithmetic processing apparatus according to claim 1, wherein
in order to perform processing of column vector data of multiple heads without adding hardware,
the arithmetic processing apparatus is further configured to simulate multi-head processing by performing transfer and receiving of arrays and accumulation of product-sum operations dividedly and sequentially in a head order.

9. The arithmetic processing apparatus according to claim 6, further comprising:
in order to address an issue with a different number of channels or a different number of sequences,
the network that is divided according to a number of channels or a number of sequences, and
a circuit element configured to couple the data readout daisy chain to the data input daisy chain.
